(19) United States
(12) Patent Application Publication
(10) Pub. No.: US 2013/0041876 A1
(43) Pub. Date: Feb. 14, 2013

(54) LINK RECOMMENDATION AND DENSIFICATION

(71) Applicants: Paul Alexander Dow, San Francisco, CA (US); Shankar Kalyanaraman, San Francisco, CA (US); Ittai Abraham, San Francisco, CA (US); Sameer Indarapu, Mountain View, CA (US)

(72) Inventors: Paul Alexander Dow, San Francisco, CA (US); Shankar Kalyanaraman, San Francisco, CA (US); Ittai Abraham, San Francisco, CA (US); Sameer Indarapu, Mountain View, CA (US)

(21) Appl. No.: 13/205,274

(22) Filed: Aug. 8, 2011

(51) Int. Cl. G06F 17/30

(52) U.S. Cl. 707/706; 707/769; 707/726; 707/E17.108

(57) ABSTRACT

Links to web content can be identified as a function of one or more links shared by a user of an online social network service, among other things. The identified links can represent recommended links likely to be interesting to the user. Densification techniques can be employed to address data sparsity and thus enhance link recommendation. Furthermore, recommended links can be integrated with a search engine to personalize interaction with web content.

### BACKGROUND

A search engine is employed to maximize the likelihood of locating meaningful information amongst an abundance of data. Sets of data, such as World Wide Web (web) resources (e.g., webpages with text, images, audio, and/or video), are analyzed and automatically indexed. Upon receipt of a query, a search engine utilizes a generated index to locate and return relevant search results expeditiously. The search results can subsequently be presented to a user in numerous ways. For example, a number of uniform resource locators (URLs), or links, can be returned identifying specific webpages that satisfy a query. Alternatively, a tiled set of thumbnails representing images can be presented as results of a search over an image database, for instance. To improve relevance of search results, a search engine can seek to employ additional contextual information regarding a user such as the user's current geographic location.

Social networking services continue to be quite popular. A social network is a social structure made up of individuals or contacts connected by various types of relationships including friendship, kinship, business, and/or common interest, among other things. A social networking service is an online service that enables service users to establish social relationships with other users as well as share data of interest to some or all of associated users. In this context, each user is represented by a profile that identifies various aspects of a user to associated users, such as demographic information (e.g., gender, age, location, educational level . . . ), and a set of interests such as hobbies or professional skills. Users may choose to share certain social data items with others including public or target messages, images, files, or links to interesting resources such as a webpage.

Social search involves employing a social networking service in combination with a search engine to allow results of an executed query to be tailored to a particular user. For example, demographic information from a social networking profile can be utilized to tailor returned results of a search query to a particular user.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to link recommendation and densification to facilitate search. Numerous techniques can be utilized to analyze user behavior with respect to social network services, such as link sharing, and recommend links that a user may find interesting. Furthermore, one or more densification techniques can be employed to expand the set of links from which recommendations are selected to overcome data sparseness, which may limit the effectiveness of identifying personalized link recommendations. Such recommendations can subsequently be integrated with query-specific search results to provide a personalized search experience.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a social search system.

FIG. 2 is a block diagram of a representative search-engine system.

FIG. 3 is a block diagram of an exemplary pipeline implementation of link recommendation.

FIG. 4 is a flow chart diagram of a method of link recommendation.

FIG. 5 is a flow chart diagram of a method of identifying similar links based on content.

FIG. 6 is a flow chart diagram of method of integrating recommended results into a search-engine result page.

FIG. 7 is a schematic block diagram illustrating a suitable operating environment for aspects of the subject disclosure.

### DETAILED DESCRIPTION

Links shared with members of a social network, such as social network contacts, (e.g., friend, follower, fan . . . ), can be input to a search engine to provide social search. If a set of search results supplied in response to a search engine query includes links previously shared by a user, the shared links can be highlighted to distinguish the shared links from other search result links. Similarly, links shared by social network contacts of the user can be highlighted. This is a very simplistic form of recommendation. Furthermore, the set of links shared by a single individual, as well as social network contacts of the individual, is very sparse. As a result, social input can go largely unseen with respect to search results.

Details below are generally directed toward link recommendation and densification for social search. Numerous techniques can be utilized to analyze user behavior with respect to social network services, such as link sharing, and supply personalized recommendations of links a user may find interesting. However, data sparseness may limit the effectiveness of the aforementioned techniques. To overcome data sparseness a number of densification techniques can be employed to expand the set of links available for recommendation. Personalized link recommendations can subsequently be integrated with search results to provide a personalized search experience.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

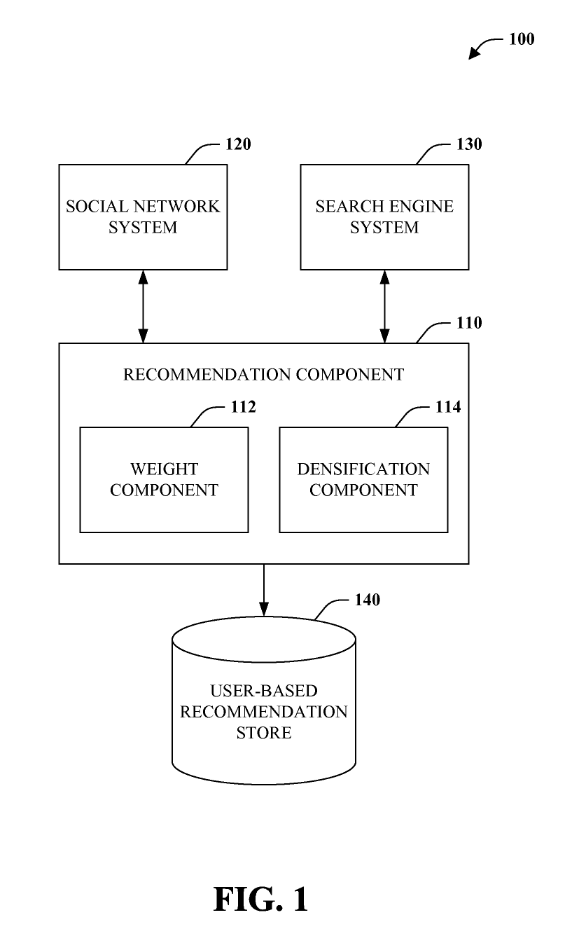

Referring initially to FIG. 1, a social search system 100 is illustrated. The social search system 100 includes recommendation component 110 communicatively coupled with social network system 120 and search engine system 130.

The social network system 120 is a collection of components that provide an online social network service that allows a user to create a social profile that represents and describes the user and establish associations representing various types of relationships with other users (e.g., family members, friendships, acquaintances, colleagues, fans . . . ). Further, the social network system 120 can enable exchange of information including demographic information (e.g., age, academic history, career history, interests . . . ), messages (e.g., personal messaged directed to particular users, or user groups, chat messages delivered to particular users participating in a chat session, public comments that may be viewed by many users of the social network service . . . ), as well as other data (e.g., documents, images, music videos, files . . . ). In one instance, the social network system 120 can be embodied as a website that provisions the aforementioned and other functionality. Exemplary social network systems include but are not limited to Facebook®, LinkedIn®, MySpace®, and Google+®.

The search engine system (or simply search engine) 130 comprises a number of components that enable receipt of a search query from a user over a set of data and return of a set of search results. Search engine systems can be designed to operate over specific data sources. One prominent type of search engine system 130 is a web search engine, which is configured to index a set of web resources or content such as websites with various web pages including text, images, audio, or video accessible by way of the Internet. Upon receipt of a search query from a user, a web search engine can identify webpages relevant to the search query and return a set of links on a search engine result page (SERP). These links identify and designate a network location of web resources, for instance in terms of a plurality of uniform resource locators (URLs). While relevant to a specified search query, the search results are typically impersonal. Stated differently, the search results do not take into account details of the user of the search engine.

The recommendation component 110 is configured to employ social signals, or in other words user information captured by the social network system 120, to personalize search results afforded by the search engine system 130. In one instance, the recommendation component 110 can save identified user recommendations to persistent user-based recommendation store 140 in a variety of forms. Additionally or alternatively, the recommendation component 110 can communicate recommendations to the search engine system 130.

More specifically, the recommendation component 110 can utilize user-shared links, among other things, to recommend links for integration with the search results. A simple embodiment involves recommending links to a user that were shared by the user or social network contacts. For instance, if the user or a member of the user's social network shared a link to a particular news story, the link to that particular news story can be recommended. However, the number of links shared by individual users and members of the users' social networks are very sparse. By way of example, if a user shares five links and twenty members of the user's social network share five links, there are one-hundred and five links for recommendation, which is very small in comparison to the number of available web resources. As a result, recommendations can go largely unseen or are not search-query relevant. To address this issue, an extended set of links can be utilized to make recommendations.

The recommendation component 110 can be configured to utilize a number of techniques to identify links a user may be interested in as a function of the user's behavior or activity in online social networks and more specifically the set of links the user has shared. In other words, the recommendations are predictions of the sort of links a user may be interested in and may want to share.

One technique for recommendation is collaborative filtering, which can be employed to exploit similarity features. Similar links can be recommended to users that have shared a link, wherein various similarity metrics can be utilized to determine similarity between users and links as discussed further below. Various techniques can be utilized with respect to recommending similar links such as user-based top-N (N is a positive integer) recommendation and link-based top-N recommendation.

With user-based top-N recommendation, users are grouped together based on some similarity metric. For any user, a set of other social network service users most similar to that user is determined and an aggregated set of links corresponding to this sorted list is generated, sorted in order of multiplicity of number of links shared, for example. Finally, the top-N links (“N” is a positive integer) are returned.

As per link-based top-N recommendation, for each shared link, a set of links most similar to a shared link is generated. Taking a union of the top-N (“N” is a positive integer) of set of links for each link and removing those links shared by a user set “S” is produced. Pairwise similarity score can then be computed between each link in the set “S” and a user's set of shared links. The set of links can then be sorted by similarity score and the top-N links returned.

Such collaborative filter techniques analyze the set of links a user likes without regard to members of the user's social network. The advantage is that, because the links the user shares are often public and members of the user's social network are not, analysis can proceed on a large set of information. By way of example, if the user is a fan of Pink Floyd and shares links pertaining to the band, other users of a social network that share the same links can be analyzed to identify additional links for recommendation. In this example, it can be inferred, for instance, from the fact that most people that share similar links also share links regarding a Pink Floyd movie that the user might be interested in links pertaining to the movie.

Another technique for identifying links of interest to a user that is also independent of a user's social network contacts is content-based recommendation. Here, content of a web resource and any user-generated content related to that resource (e.g., social network captions or comments) can be inspected to discover other resources of with similar content. For example, similar webpages can be recommended to users that have shared links to a webpage. One way to discover similar webpages is to exploit a search engine. From content of a shared web page, a query or set of queries can be identified that represent that page. The queries can be as simple as the words in the title of the webpage or the set of search queries that most frequently return the webpage, among other things. Once a query is extracted it can be supplied to the search engine system 130, and the top-N returned search results identified as similar webpages.

Personalized graph-based relevance techniques can also be employed by the recommendation component 110 or more specifically weight component 112. Here, the most relevant links for a user can be computed by applying a “personalized” variant of known relevance algorithms including HITS (Hyperlink-Induced Topic Search) and SALSA (Stochastic Approach to Link Structure). In one embodiment, a user-link bipartite graph can be constructed based on link sharing in social networks and used in combination with members of a user's social network as implied by connections in a social network to identify personally relevant links to a user. In other words, a global weight is not computed but rather a rank given a particular source, namely a user. This weighting or ranking injects a bias such that when links are close to a source they are given a larger weight than if they are far away in graph terms.

Additionally, the granularity of such relevance techniques can be enhanced by employing activity of members of a user's social network to increase or decrease weights on a on a user's connection to a link instead of just a binary relationship indicating whether a user has or has not shared a given link. In one embodiment, weight can be increased on a link if many members of a user's social network also shared the link. In another embodiment, temporal features can be incorporated into weight determination. For example, consider a user that wants to be the first to share a link that many members of the user's social network go on to share. In this case, weight can be decreased on links that many members of a user's social network shared before the user shared the links. The user would benefit from recommendation of these sorts of links earlier than others. In other situations, it may make sense to weight more heavily the links a user shared before members of the user's social network.

The recommendation component 110 can be configured to employ a hybrid of different techniques for recommending links. By way of example and not limitation a combination of graph-based relevance and content-based recommendation can be employed to tailor recommendation to available resources and data obtained from a social graph and a web graph.

Although there are known techniques for computing a similarity metric (e.g., Cosine, Pearson . . . ), here the problem considered is somewhat unique in that there are different interactions that occur within a social network, each with a different notion of similarity. For example, similarity based on an explicit relation defined between any two users (e.g., members of same social network); similarity based on common links shared by other users; and similarity explicit in the links because of content. Each such notion of similarity is distinct, but can be combined with other notions.

For user-centric similarly, content-based features can include access to a user's profile information. Accordingly, metadata regarding location, networks, organizational membership, interests, etc. can be tapped to establish similarity among social network users. With respect to graph-based features, the graph properties inherent in a problem structure can be utilized. More specifically, a social graph of users (e.g., comprising both edges to members of a user's social network and edges to different links that the user has shared) can be exploited by determining social distance between any two users based on: 1) number of mutual (distance-1) neighbors, distance-2 neighbors, etc. or 2) number of common links shared by the users, number of common links shared by distance-1 neighbors, etc.

As per link-centric similarity, content-based features can include metadata about a link domain. In addition, a search engine's query logs can be tapped to determine additional information about a link such as what query keywords will trigger the link as a search result, click-through rate, anchor text, captions, and incoming and outgoing links, among other things. Using these features, it can be determined which links are similar based on common anchor text, captions, as well as incoming and outgoing links, for example. Social graph information can also be utilized for each link analogous to how the graph is used for computing user similarity as described above. More specifically, a contribution to a similarity score between to links can be based on the number of users that share both links. Additionally or alternatively, two links can be identified as similar if the social distance between users that share the links is small. Here, social distance is based on the user similarity metric as discussed above.

The aforementioned techniques employed by the recommendation component 110 extend the set of links that can be recommended beyond links shared by a user or social network contacts of the user. However, data sparsity can still negatively affect generation of highly relevant links. In order to identify quality recommendations for the greatest number of users, additional techniques can be employed to deal with data sparsity. Densification component 114 is configured to employ one or more of such techniques to expand the set of links available to the recommendation component 110. What follows is a number of exemplary densification techniques that can be utilized.

First, similar links can be clustered. As previously described, the recommendation component 110 can recommend links to user that reference content that is similar to that referenced by links shared by the user. Here, a user sharing a link can be treated as equivalent to sharing other links similar to that link. This will increase the shares per user and shares per link.

Recommendation techniques can be bootstrapped with each other. Any recommendation technique can be employed to identify recommended links for a set of users. Those recommended links can then be treated as if a corresponding user had shared the recommend links thus increasing the number of shared links per user.

User can be replaced by clusters of users to improve data density. Using a social graph identifying social network users, clusters of closely connected user can be identified. A single user can belong to more than one cluster. Instead of identifying recommendations based on users and the links they share, recommendations can be based on clusters of users and the mathematical union of the shared links of the users in the cluster. This will increase the number of shared links per “user,” because a “user” is a cluster of users. It may also increase the shares per link if a single user can be in multiple clusters. One method of clustering is to select the set of maximal cliques in a social graph such that ever user is in at least one clique.

Domain based clustering can be utilized. With this technique, a user sharing a link to a top-level domain to mean the user is interested in seeing links to specific webpages within that domain. This allows reduction of links belonging to a specific top-level domain to a single equivalence class. For example, “www.cnn.com” incorporates all articles appearing on CNN. Accordingly, a user that shares a link to “www.cnn.com” can be recommended articles from that site that are relevant to a query.

Links can be clustered based on metadata and query patterns to expand the set of potential links. For instance, given access to phrases accompanying a link that characterize the title or contain a brief snippet of an article, links that include similar titles or descriptions can be aggregated into a single cluster and any link from this cluster relevant to a query can be recommended (e.g., if the query matches with title and description). A more generalized approach is to perform topic classification based on contextual information obtained from link metadata (e.g., header, title . . . ), as well as query keywords that would trigger the link. Subsequently, within each cluster, links can be returned that are most similar/relevant to a user and a query. Given a link, a search engine's index and query logs can be exploited for that particular link. This will provide information about query keywords, as well as information on outgoing edges to other links. Such outgoing links can be mapped to the original link, and included in a set of candidate recommendations.

Link-similarity based densification can be employed. Given a set of links returned by a search engine, similarity between these links and those shared by members of a user's social network can be computed. For example, the top five most-similar links can be returned as long as they cross a certain similarity threshold (and regardless of whether this links are matched exactly). This corresponds to query-dependent graph-based link recommendation.

User-similarity densification can be utilized. Here, social network contacts of a user can be sorted based on similarity and a set of links from a predetermined number of most similar users proportional to the similarity score can be returned and employed for recommendation.

Query logs available for each user-shared link can be employed in a query-based clustering technique. In particular, a set of queries can be retrieved that would trigger a user-shared link as a search result and links that are triggered by the same queries (e.g., up to minor differences) can be mapped to a single cluster, thereby constructing a link-query graph. The rationale here is that given a query and the top-ranked results, lower ranked results can be returned when they otherwise would not be returned.

The densification component 114 can be included within the recommendation component 110 as shown or independent thereof. Further, in accordance with one embodiment the densification component 114 can be invoked prior to other recommendation techniques. This is especially beneficial in scenarios in which user shared links are so sparse as to result in inferior or trivially empty recommendations being returned. Further, many techniques used for recommendation can also be employed to overcome data sparsity including the content-based recommendation technique.

Additionally, data sparsity can be addressed based on concepts of user-user similarity and link-link similarity. As per user-similarity based densification, given two users and their respective sets of shared data links, both sets can be augmented in a randomized manner by including shared links from the other user with a probability that is proportional to the mutual similarity score between the two users. With respect to link-similarity based densification, given any two links and their respective sets of users, each user's sets of links can be augmented with the other link in a randomized manner with probability that is proportional to the mutual similarity score between two the two links.

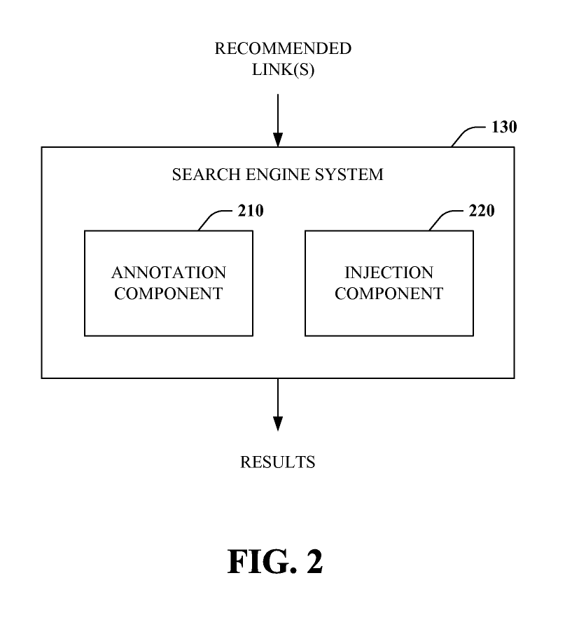

Turning attention to FIG. 2, a representative search-engine system 130 is depicted. The search engine system 130 can be provided with, or can acquire from a source, one or more recommended links that can be incorporated into the search engine system 130 to enable search personalization based on social interaction, or in other words social search. The search engine system 130 can include annotation component 210 and/or injection component 220.

The annotation component 210 is configured to annotate recommended links in various ways to distinguish recommended links from other links in a result set. Recommended links can be annotated with color, pictures, text, or other markings. This does not require any additional ranking work or attempts to match the content of the recommendations to a query.

There are several techniques to annotate search results in order to convey to a user that the result is personalized to the user. By way of example and not limitation, results can be labeled with text identifiers that indicate why a result is being set apart from others. “Recommended for you” can be one identifier that states that a user might be personally interested in a particular link based on the set of links the user has shared on a social network. “Recommend for you and your friends” is another identifier that indicates that the user and social network contacts of the user (e.g., friends, follows, fans . . . ) might be interested in a specific link based on the set of links shared thereby. “You will like this, because you liked ______” is another label that identifies a link the user shared that caused recommendation of the annotated link.

According to one embodiment, the recommendation component 110 of FIG. 1 can provide a set of recommended links to the search engine system 130. The search engine system 130 by way of the annotation component 210 can seek to match links of a set of search results with provided recommended links. If a search result link matches a recommended link, the annotation component 210 can annotate the search result link in a manner to set it apart from other search result links.

In accordance with another embodiment, a pipeline of processing elements can be assumed wherein after receiving a user's query and generating a result set, the search engine passes the result set to a local or remote service (e.g., annotation component 210 perhaps included as part of recommendation component 110) that looks up the set of recommendations for the user and determines if any of the recommended results are in the result set. After identifying a recommended link in the result set, additional data can be appended to the link to annotate the link when rendered to the user as part of the result set.

The injection component 220 is configured to inject or insert recommended links into a result set that are not already in the result set. Here, matching can be performed on a user's query to identify an appropriately relevant recommended link and position the recommended link within the search result set. Various techniques/mechanisms can be utilized to provide such functionality. In one non-limiting instance, a technique to boost low-ranked results and a recommended link index can be employed.

A search engine result set typically includes ten links, though the index often returns a larger set of relevant links that are not shown unless a user selects results past the first page. A comparison can be made between lower-ranked results returned by the index (e.g., results 11-50) with a set of recommended links for a user. If there is a match, a recommended link can be moved into the top ten search results. Since the a link has already been determined to be relevant to a user query and assuming that the link is recommended to the user, the link is more relevant to the user and can be provided with a higher ranking.

A recommended link index can be constructed that includes links recommended for one or more users, similar to an index used to find relevant content for a search query. Queries received by a search engine can be fed into this index and matching pages recommended for a particular user returned and provided as part of the search results.

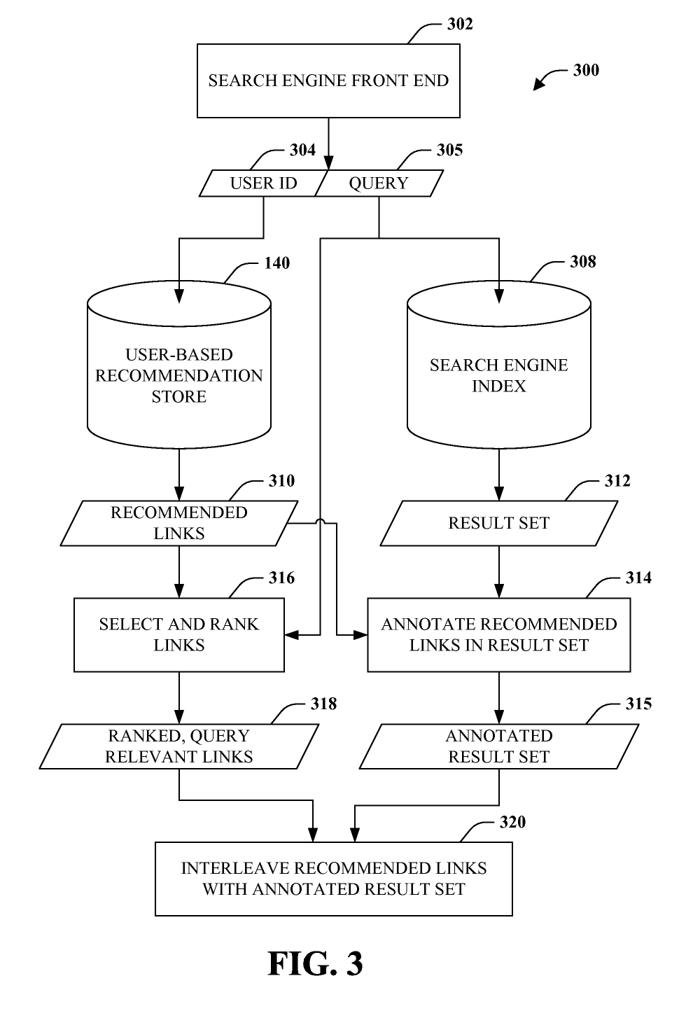

FIG. 3 illustrates an exemplary pipeline implementation of aspects of the subject disclosure 300. A pipeline is a chain of processing elements, such as processes, threads, co-routines, etc., arranged such that the output of an element is input to a next element. Search engine front end 302 can acquire a user identifier 304 and query 305 supplied by a user, which are provided to user-based recommendation store 140 and search engine index 308, respectively. The user-based recommendation store can then employ the user identifier 304 to locate recommended links, for example in the form of uniform resource locators (URLs). The search engine index 308 can be utilized to identify a result set 312 of links relevant the query 305. The recommended links 310 can be input to a processing element 314 that annotates recommended links matching links in the result set 312 to produce annotated result set 315. Another processing element 316 can acquire the query 305 and recommended links 310 as input, and select and rank links resulting in ranked, query relevant links 318. Finally, the ranked, query relevant links 318 can be injected within, or in other words interleaved with, the annotated result set 315 by processing element 320.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the recommendation component 110 can employ such mechanisms to facilitate identification of links to recommend to a user.

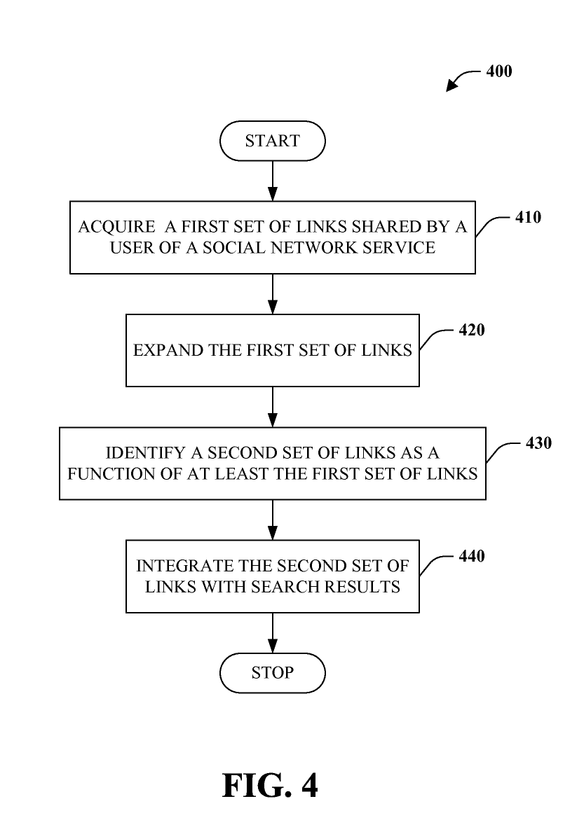

In view of the exemplary systems described supra, methodologies that may be implemented in accordance with the disclosed subject matter will be better appreciated with reference to the flow charts of FIG. 4-6. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 4, a method 400 of link recommendation is illustrated. At reference numeral 410, a first set of links shared by a user of a social network service with other users of the social network service is acquired. For example, a user may share a link to a webpage including an article of interest with social network contacts. At numeral 420, the first set of links can be expanded. A number of techniques can be employed to expand the set of links to include those that are similar to the first set of links where similarity can be between links and/or users, for instance. By way of example and not limitation, various clustering techniques can be employed (e.g., page, domain, query, user . . . ). At reference numeral 430, a second set of links can be identified as a function of at least the expanded first set of links. For instance, collaborative filtering and personalized relevance techniques can be employed over the expanded first set of links to identify personalized recommendations of links. At reference numeral 440, the second set of links can be integrated with search results. Such integration can comprise one or more of annotating search result links that match recommended links or injecting recommended links into the result links (e.g., improving ranking, adding to a particular location on search result page . . . )

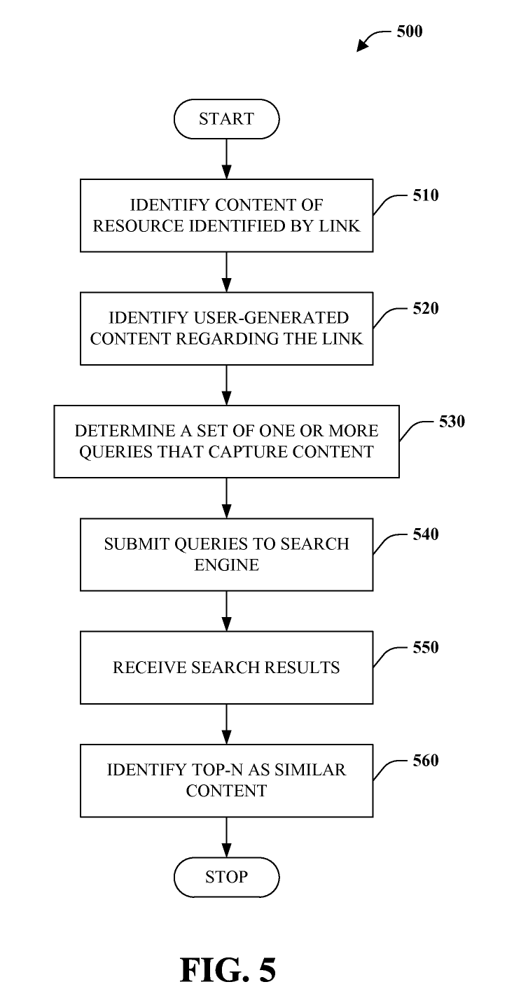

FIG. 5 depicts a method 500 of identifying similar links based on content. At reference numeral 510, content of a resource referenced by a link shared by a user is identified. For example, content supplied by a webpage is identified. At numeral 520, user-generated content regarding the link is identified including but not limited to any captions or comments regarding the link by the user. At numeral 530, a set of one or more queries that capture resource or user-generated content is determined. For instance, a query can correspond to the title of a webpage or a set of queries that frequently return a particular webpage. At references 540 and 550, the determined queries are submitted to a search engine and search results are received, respectively. At reference numeral 560, the top-N (where N is a positive integer) search result links are identified as similar content.

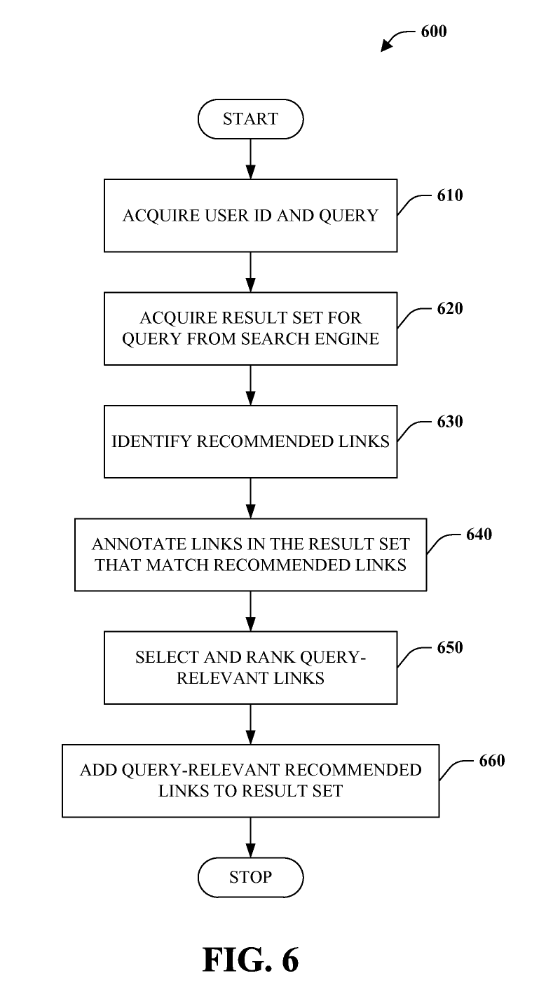

FIG. 6 is a flow chart diagram of a method 600 of integrating recommended links in to a search-engine result page. At reference numeral 610, a user identifier and a query associated with the user-identifier are acquired. The user identifier is a unique identifier of a particular user or computer. In one instance, the user identifier can be provided as a consequence of authentication with a search engine or social network service. A result set for the query is acquired from a search engine in response to submission of the query. At numeral 630 a set of recommended links is identified, for example by employing collaborative filtering, ranking and/or densification techniques. At reference 640, links in the result set matching links the set of recommended links are annotated with additional information to allow such links to be distinguished from other links. At 650, query relevant links are selected from the set of recommended links and ranked. At reference numeral 660, query-relevant recommended links are added to the result set.

Recommendation herein focuses primarily on utilizing a user's history of sharing links on one or more social networks as well as collective link sharing behavior across the one or more social networks. However, other social signals can be utilize to aid in link recommendation and/or densification. By way of example and not limitation, if a user provides positive feedback with respect to a link by “liking” the link, for instance, such a social signal can be utilized to aid ranking links or weighting social network contacts. In particular, these links or contacts can be given preferential treatment with respect link recommendation and/or densification techniques.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

The conjunction “or” as used this description and appended claims in is intended to mean an inclusive “or” rather than an exclusive “or,” unless otherwise specified or clear from context. In other words, “X or Y” is intended to mean any inclusive permutations of “X” and “Y.” For example, if “A employs X,” “A employs Y,” or “A employs both A and B,” then “A employs X or Y” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

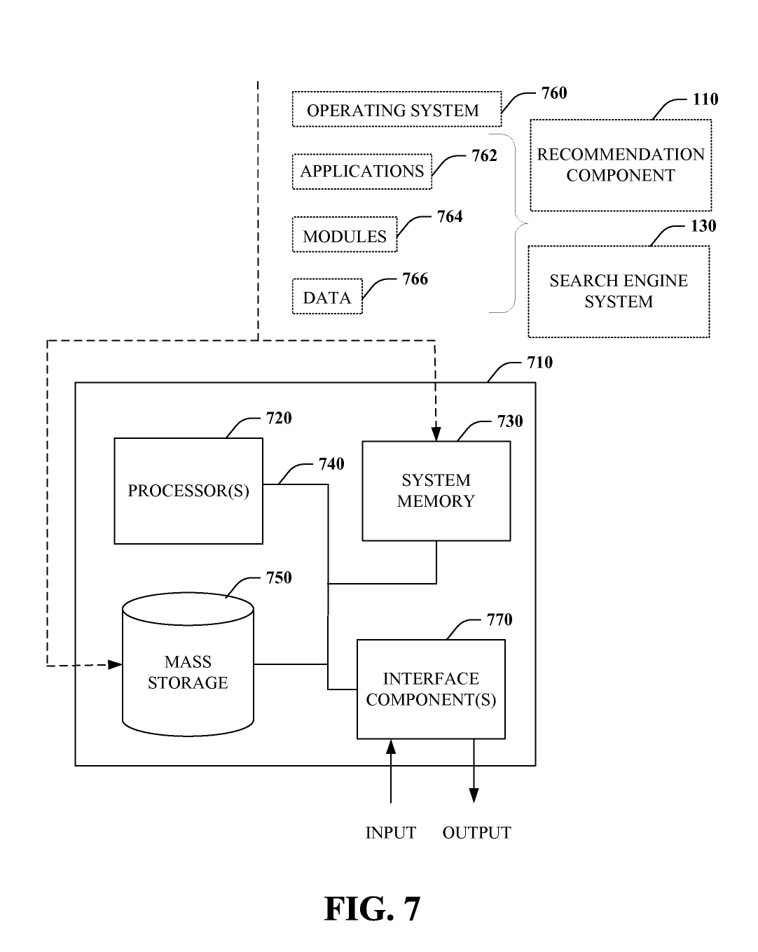

In order to provide a context for the claimed subject matter, FIG. 7 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 7, illustrated is an example general-purpose computer 710 or computing device (e.g., desktop, laptop, server, hand-held, programmable consumer or industrial electronics, set-top box, game system . . . ). The computer 710 includes one or more processor(s) 720, memory 730, system bus 740, mass storage 750, and one or more interface components 770. The system bus 740 communicatively couples at least the above system components. However, it is to be appreciated that in its simplest form the computer 710 can include one or more processors 720 coupled to memory 730 that execute various computer executable actions, instructions, and or components stored in memory 730.

The processor(s) 720 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 720 may also be implemented as a combination of computing devices, for example a combination of a DSP and a microprocessor, a plurality of microprocessors, multi-core core processors, one or more microprocessors in conjunction with a DSP core, or any other such configuration.

The computer 710 can include or otherwise interact with a variety of computer-readable media to facilitate control of the computer 710 to implement one or more aspects of the claimed subject matter. The computer-readable media can be any available media that can be accessed by the computer 710 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 710.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 730 and mass storage 750 are examples of computer-readable storage media. Depending on the exact configuration and type of computing device, memory 730 may be volatile (e.g., RAM), non-volatile (e.g., ROM, flash memory . . . ) or some combination of the two. By way of example, the basic input/output system (BIOS), including basic routines to transfer information between elements within the computer 710, such as during start-up, can be stored in nonvolatile memory, while volatile memory can act as external cache memory to facilitate processing by the processor(s) 720, among other things.

Mass storage 750 includes removable/non-removable, volatile/non-volatile computer storage media for storage of large amounts of data relative to the memory 730. For example, mass storage 750 includes, but is not limited to, one or more devices such as a magnetic or optical disk drive, floppy disk drive, flash memory, solid-state drive, or memory stick.

Memory 730 and mass storage 750 can include, or have stored therein, operating system 760, one or more applications 762, one or more program modules 764, and data 766. The operating system 760 acts to control and allocate resources of the computer 710. Applications 762 include one or both of system and application software and can exploit management of resources by the operating system 760 through program modules 764 and data 766 stored in memory 730 and/or mass storage 750 to perform one or more actions. Accordingly, applications 762 can turn a general-purpose computer 710 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the recommendation component 110, the search engine system 130, or portions thereof, can be, or form part, of an application 762, and include one or more modules 764 and data 766 stored in memory and/or mass storage 750 whose functionality can be realized when executed by one or more processor(s) 720.

In accordance with one particular embodiment, the processor(s) 720 can correspond to a system on a chip (SOC) or like architecture including, or in other words integrating, both hardware and software on a single integrated circuit substrate. Here, the processor(s) 720 can include one or more processors as well as memory at least similar to processor(s) 720 and memory 730, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the recommendation component 110, the search engine system 130, and/or associated functionality can be embedded within hardware in a SOC architecture.

The computer 710 also includes one or more interface components 770 that are communicatively coupled to the system bus 740 and facilitate interaction with the computer 710. By way of example, the interface component 770 can be a port (e.g., serial, parallel, PCMCIA, USB, FireWire . . . ) or an interface card (e.g., sound, video . . . ) or the like. In one example implementation, the interface component 770 can be embodied as a user input/output interface to enable a user to enter commands and information into the computer 710 through one or more input devices (e.g., pointing device such as a mouse, trackball, stylus, touch pad, keyboard, microphone, joystick, game pad, satellite dish, scanner, camera, other computer . . . ). In another example implementation, the interface component 770 can be embodied as an output peripheral interface to supply output to displays (e.g., CRT, LCD, plasma . . . ), speakers, printers, and/or other computers, among other things. Still further yet, the interface component 770 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating link recommendation, comprising:
employing at least one processor configured to execute computer-executable instructions stored in memory to perform the following acts:
identifying a second set of one or more links to web content as a function of a first set of one or more links shared by a user of an online social networking service.

2. The method of claim 1, identifying the second set of one or more links as a function of content referenced by a link shared by the user.

3. The method of claim 2, identifying the second set of one or more links from results produced by a search engine in response to one or more queries generated based on the content.

4. The method of claim 1, identifying the second set of one or more links as a function of similarity between users of the online social networking service.

5. The method of claim 1, identifying the second set of one or more links as a function of similarity between links shared by users of the online social networking service.

6. The method of claim 1 further comprises weighting the second set of one or more links as a function of social network contacts of the user.

7. The method of claim 1 further comprises appending annotation data to a link in a set of search results that matches one of the one or more links of the second set.

8. The method of claim 1 further comprising identifying query-specific links from the second set of one or more links.

9. The method of claim 1 further comprises adding the second set of links to a recommended link index.

10. A system that facilitates search, comprising:
a processor coupled to a memory, the processor configured to execute the following computer-executable components stored in the memory:
a first component configured to recommend, on a search-engine result page, a second set of one or more links to web content identified as a function of a first set of one or more links shared by a user of a social network service.

11. The system of claim 10, the second set of one or more links is identified based on content of the one or more links shared by the user.

12. The system of claim 10, the second set of one or more links is identified based on comments with regard to the one or more links shared by the user.

13. The system of claim 10, the second set of one or more links is identified based on links that are similar to the first set of one or more links shared by a user.

14. The system of claim 10, the second set of one or more links is identified as a function of a user cluster.

15. The system of claim 10, the second set of one or more links is identified as a function of a domain cluster.

16. The system of claim 10, the second set of one or more links is identified as a function of a search engine query that returns one or the one or more links shared by the user.

17. A computer-readable storage medium having instructions stored thereon that enables at least one processor to perform the following acts:
identifying a second set of one or more links to web content as a function of a first set of one or more links shared by a user of an online social network service with other users of the social network service.

18. The computer-readable storage medium of claim 17 further comprising ranking the second set of one or more links as a function of link sharing behavior of social network contacts of the user.

19. The computer-readable storage medium of claim 17, identifying the second set of one or more links as a function of content referenced by at least one link of the first set of one or more links shared by the user.

20. The computer-readable storage medium of claim 17 further comprising identifying a third set of one or more links based on the second set of one or more links.
